(19) United States
(12) Patent Application Publication
(10) Pub. No.: US 2010/0039729 A1
(43) Pub. Date: Feb. 18, 2010

(54) PACKAGE WITH INTEGRATED MAGNETS FOR ELECTROMAGNETICALLY-ACTUATED PROBE-STORAGE DEVICE

(75) Inventors: John Heck, Berkeley, CA (US); Nickolai Belov, Los Gatos, CA (US); Steve Greathouse, Nampa, ID (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 12/192,009

(22) Filed: Aug. 14, 2008

(51) Int. Cl. G11B 5/127

(52) U.S. Cl. 360/110; G9B/5.04

(57) ABSTRACT

A packaged memory device for storing information comprises a stack, a package lid, a first magnet structure fixedly connected to the package lid, a package body and a second magnet structure connected with the package body. The stack includes a tip substrate, a cap, and a media arranged between the tip substrate and cap and movable relative to the tip substrate. The tip substrate includes a plurality of tips extending from the tip substrate so that the tips can access the media. The first magnet structure includes a first magnet connected with a first flux plate. The second magnet structure includes a second magnet connected with a second flux plate. The second flux plate is integrated with the package body so that the second flux plate provides structural rigidity to the package body. The stack is connected to one or both of the package body and the second magnet.

### CROSS-REFERENCE TO RELATED PATENT APPLICATIONS

This application incorporates by reference the following co-pending application:

U.S. patent application Ser. No. ______, entitled “Low Distortion Package for a MEMS Device Including Memory,” Attorney Docket No. NANO-0114US0, filed concurrently.

### BACKGROUND

Software developers continue to develop steadily more data intensive products, such as ever-more sophisticated, and graphic intensive applications and operating systems (OS). Higher capacity data storage, both volatile and non-volatile, has been in persistent demand for storing code for such applications. Add to this need for capacity, the confluence of personal computing and consumer electronics in the form of personal MP3 players, such as iPod®, personal digital assistants (PDAs), sophisticated mobile phones, and laptop computers, which has placed a premium on compactness and reliability.

Personal computing and consumer electronics commonly use memory cards that conform to one of several memory card standards that define, among other things, package form factor, pin arrangement, communication protocol, etc. FLASH memory is commonly used as the media contained in such memory cards, and provides a readily accessible, solid-state solution to the lag time and high power consumption problems inherent in other memory devices such as hard disk drives. However, the cost per megabyte is dramatically higher than the cost per megabyte of an equivalent amount of space on a hard disk drive. Further, FLASH memory stores bits in cells comprising arrays of floating-gate transistors that require significant chip surface, limiting a maximum achievable areal density. There is a need for solutions which permit higher density data storage in a consumer-friendly form factor at a reasonable cost per megabyte.

### BRIEF DESCRIPTION OF THE DRAWINGS

Further details of the present invention are explained with the help of the attached drawings in which:

FIG. 1 is a simplified cross-sectional view of a memory device.

FIG. 2 is a partially exploded perspective view of the memory device of FIG. 1 and a package to house the memory device.

FIG. 3 is a simplified cross-sectional view of the memory device of FIG. 1 arranged within a package.

FIG. 4A is a cross-sectional view of an embodiment of a memory device and package in accordance with the present invention, wherein a portion of the support surface of the package comprises a pair of magnet assemblies.

FIG. 4B is a cross-sectional view of an alternative embodiment of a memory device and package in accordance with the present invention, wherein a magnet assembly is mounted within a bottom portion of the package and a magnet assembly is fixedly connected with a top portion of the package.

FIG. 4C is a cross-sectional view of a further embodiment of a memory device and package in accordance with the present invention, wherein a pair of magnet assemblies are mounted within corresponding components of the package.

FIG. 4D is a cross-sectional view of a still further embodiment of a memory device and package in accordance with the present invention, wherein a portion of the support surface of the package comprises a magnet assembly and a magnetic flux return plate.

FIG. 4E is a cross-sectional view of a still further embodiment of a memory device and package in accordance with the present invention, wherein a portion of the support surface of the package comprises a pair of magnet assemblies, and wherein magnets of the magnet assemblies are at least partially arranged within corresponding pockets of a tip substrate and a cap.

FIG. 4F is a cross-sectional view of a still further embodiment of a memory device and package in accordance with the present invention, wherein a portion of the support surface of the package comprises a pair of magnet assemblies, and wherein magnets of the magnet assemblies are at least partially arranged within corresponding pockets of a tip substrate and a cap.

FIG. 4G is a cross-sectional view of a further embodiment of a memory device and package in accordance with the present invention, wherein the memory device comprises a single magnet assembly with a magnet of the magnet assembly at least partially arranged within corresponding pockets of a cap, and further comprising a tip substrate thinned to a reduced height.

### DETAILED DESCRIPTION

Common reference numerals are used throughout the drawings and detailed description to indicate like elements; therefore, reference numerals used in a drawing may or may not be referenced in the detailed description specific to such drawing if the associated element is described elsewhere.

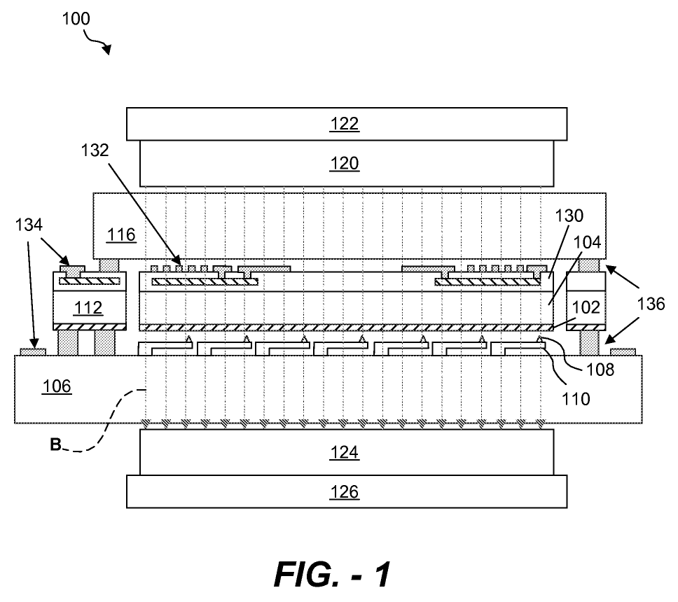

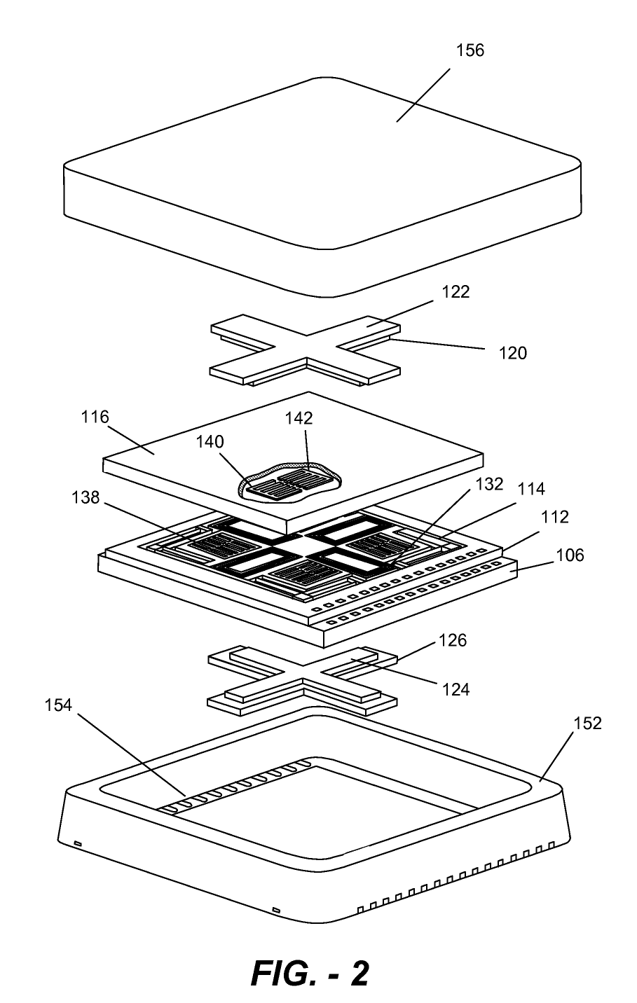

FIG. 1 is a simplified cross-sectional view of a system for storing information 100 (also referred to herein as a memory device) comprising a tip substrate 106 arranged generally parallel to a memory material or media 102. The media 102 is suitable for forming, removing, manipulating and/or reading indicia. Cantilevers 110 extend from the tip substrate 106 and tips 108 extend from respective cantilevers 110 toward the media 102. One or more of the tips 108 is connectable with the media 102 for forming, removing, manipulating and/or reading indicia in the media 102 and/or on the surface of the media 102. In the embodiment of FIG. 1, a media substrate 114 comprises a platform 104 suspended and movable within a frame 112 by a plurality of suspension structures (e.g., flexures 112 as shown in FIG. 2). The platform 104 carries the media 102. The tip substrate 106 is bonded to the media substrate 114 and the platform 104 (and by extension the media 102) is moved relative to the cantilevers 110. In other embodiments, one or both of the cantilevers 110 and the media 102 can be movable to allow the tips 108 to access the media 102. The memory device 100 can be electrically connected with a memory device controller by way of one or more bond pads 134.

The platform 104 formed in the media substrate 114 is movable in a Cartesian plane relative to the frame 112 by way of electromagnetic motors comprising electrical traces 132 (also referred to herein as coils, although the electrical traces need not contain turns or loops) formed on the platform 104 and placed in a magnetic field B. The platform 104 is selectively urged in a Cartesian plane by taking advantage of Lorentz forces generated by applying current to the coils 132 while the magnetic field B is applied across the coil 132 current paths. As shown, the coils 132 are arranged at ends of two perpendicular axes and are formed such that the media 102 is disposed between the coils 132 and the tip substrate 106 (e.g. fixedly connected or integrally formed with a back of the platform 104, wherein the back is a surface of the movable media platform 104 opposite a surface contactable by tips extending from the tip substrate 106). In a preferred embodiment, the coils 132 can be arranged symmetrically about a center of the platform 104, with one pair of coils generating force for lateral (X) motion and the other pair of coils generating force for transverse (Y) motion. Utilization of the tip-accessible surface of the platform 104 for data storage need not be affected by the coil layout because the coils 132 can be positioned so that the media 102 for storing indicia is disposed between the coils 132 and the tip substrate 106, rather than co-planar with the coils 132. In other embodiments the coils can be formed co-planar with the surface of movable media platform. In such embodiments, a portion of the tip-accessible surface of the movable media platform will be dedicated to the coils, reducing utilization for information storage. Further, in other embodiments the coils need not be arranged in a cross pattern, but rather can include fewer or more coils arranged in some other pattern.

The magnetic field B is generated across the platform 104 by at least one permanent magnet 120 arranged so that the permanent magnet 120 approximately maps the two perpendicular axes, the ends of which include the coils 132. In other embodiments, the permanent magnet can have some other shape, for example the permanent magnet can be sized to approximately map the media substrate. The permanent magnet 120 can be fixedly connected with a structure such as a flux plate 122 to form a magnet structure. The flux plate 122 can be formed from some material suitable for containing magnetic flux, preferably a ferromagnetic material such as alloys of nickel and/or iron (e.g., steel). A second magnet structure comprising a second permanent magnet 124 and a second flux plate 126 is shown and can be arranged so that the tip substrate 106, the platform 104, and the coils 132 are disposed between the two magnet structures. The magnetic flux spans the gap between the first permanent magnet 120 and the second permanent magnet 124. As above, the second flux plate 126 can be formed from some material suitable for containing magnetic flux, preferably a ferromagnetic material such as alloys of nickel and/or iron. As described below, in alternative embodiments, a single magnet structure and a complementary flux plate without attached magnets can be employed, where desired.

The Lorentz force generated at the coil 132 is proportional to the flux density, thus the required current and power to move the platform 104 can be increased or reduced in inverse proportion to a gap between permanent magnets 120 and 124 (assuming for the purpose of discussion that the permanent magnet type does not vary). There is a possibility that a write current applied to one or more tips could disturb the platform 104 by producing undesirable Lorentz force. However, where the media 102 comprises phase change material, polarity dependent material, ferroelectric material or other material requiring similar or smaller write currents to induce changes in material properties, platform movement due to write currents is sufficiently small as to be within track following tolerance. In some embodiments, it can be desired that electrical trace layout be configured to generally negate the current applied to the tip, thereby minifying the influence of write current. The magnet structure can be fixedly associated with a cap 116 that can be bonded to the frame 112 to seal the platform 104 between the tip substrate 106 and the cap 116.

Coarse servo control of the platform 104 within the frame 112 can be achieved through the use of capacitive sensors. Referring to the partially exploded view of FIG. 2, a capacitive sensor can comprise an electrode 138 associated with the platform 104 and one or more electrodes 140,142 associated with a structure held static relative to the movable media platform 104, such as the cap 116. Such devices and techniques for controlling movement of the platform are described in U.S. patent application Ser. No. 11/553,421, entitled “BONDED CHIP ASSEMBLY WITH A MICRO-MOVER FOR MICROELECTRO-MECHANICAL SYSTEMS,” filed Oct. 26, 2006 and incorporated herein by reference. The platform 104 can rely on a pair of capacitive sensors arranged at four locations (although alternatively more or fewer locations) using each pair of capacitive sensors for extracting a ratio-metric signal independent of Z-displacement of the platform 104. Preferably, two electrodes 140,142 are formed on the cap 116. A third electrode 138 can be integrally formed or fixedly connected with the platform 104 to form a differential pair. Two capacitors are formed, one between the first electrode 140 and third electrode 138 and one between the second electrode 142 and the third electrode 138. A ratio of capacitances can be sensitive to horizontal displacement of the platform 104 with respect to the frame 112 along an axis (X displacement) and this ratio can be insensitive to displacements of the platform 104 with respect to the frame 112 along other axes (and Z displacement). For a pair of capacitive sensors adapted to measure motion along an axis, at least two readings can be obtained from which can be extracted displacement along the axis and rotation about a center of the platform 104. Processing signals from all capacitive sensors allows extracting three displacement and three rotational components of the motion of the platform 104 with respect to the cap 116. Alternatively, coarse servo control of the media platform 104 can be achieved using some other technique and device, such as Hall-effect sensors sensitive to magnetic field, thermal sensors to detect heat sources, etc.

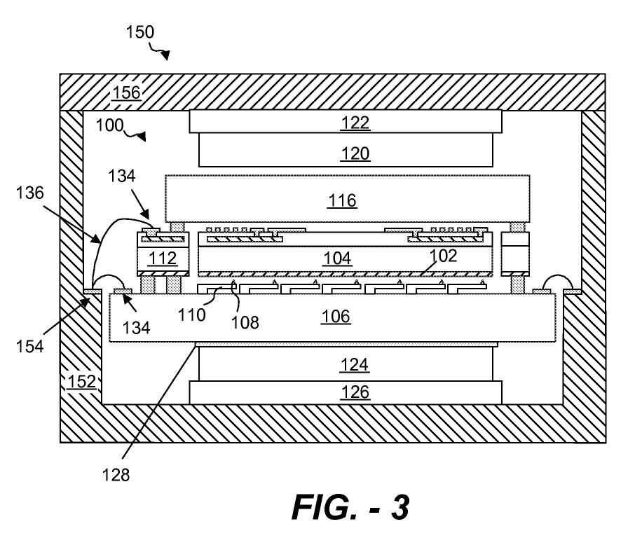

FIG. 2 is a partially exploded perspective view and FIG. 3 is a simplified cross-sectional view of the memory device 100 of FIG. 1 arranged within a package 150. The cap 116 is shown bonded to the frame 112, which is bonded to the tip substrate 106, sealing the platform 104 between the cap 116 and the tip substrate 106. A permanent magnet 120 and flux plate 122 can be adhesively connected with a lid 156 of the package (as shown) or alternatively can be adhesively connected with the cap 116. A complementary magnet structure including a second permanent magnet 124 and second flux plate 126 can be fixedly connected either with a package body 152 or with the tip substrate 106. The stack, which includes the structures arranged between the two flux plates 122, 126, can be fixedly associated with the package 150, for example by bonding the tip substrate 106 to the second flux plate 126 by an adhesion layer 156. Lead wires 136 are connected between bond pads 134 associated with the respective substrates and leads 154 that extend outside of the package 150, allowing the memory device 100 to electrically communicate with an interface controller, a host device, or other external device. Preferably, a gap exists between the first permanent magnet 120 and the cap 116 or between the first flux plate 122 and the lid 156, so that some deformation of the package 150 from compressive and tensile forces can occur without unacceptably affecting tip 108 contact and/or communication with the media 102. Alternatively, the package may optionally be filled with a fill material added to the cavity between the stack and the package body 152. The fill material can be, for example, an epoxy resin for mechanically supporting the package 150 and protecting the wire bonds and memory device 100. In still other embodiments, the cap 116 and first magnet structure can be fixedly connected with the lid 156, while a gap exists between the second magnet 124 and tip substrate 106 or second flux plate 126 and package body 152.

Consumer products such as digital cameras, cell phones, media players, and video game consoles commonly include slots for receiving and/or interfacing with memory cards. The slots are typically sized and shaped, and typically include pin arrangements which complement one (or more) of several memory card form factors such as CompactFlash (CF), MultiMediaCard (MMC), Memory Stick, Secure Digital (SD), and xD. It can be desirable to arrange a memory device in a package having a form factor resembling one or more of the different memory card standards to provide high density storage to consumer products. However, form factor dimensions can vary substantially, as shown below:

| | Width, | Length, | Thickness, |
|---|---|---|---|
| Card | mm | mm | mm |
| CompactFlash, Type I | 43.0 | 36.0 | 3.3 |
| CompactFlash, Type II | 43.0 | 36.0 | 5.0 |
| SmartMedia | 37.0 | 45.0 | 0.76 |
| MMC, MMCplus | 24.0 | 32.0 | 1.4 |
| RS-MMC, MMCmobile | 24.0 | 16.0 | 1.4 |
| MMCmicro | 14.0 | 12.0 | 1.1 |
| Memory Stick Standard, PRO | 21.5 | 50.0 | 2.8 |
| Memory Stick Duo, PRO Duo, PRO-HG | 20.0 | 31.0 | 1.6 |
| Memory Stick Micro “M2” | 12.5 | 15.0 | 1.2 |
| SD | 24.0 | 32.0 | 2.1 |
| miniSD | 20.0 | 21.5 | 1.4 |
| microSD | 15.0 | 11.0 | 1.0 |
| xD | 25.0 | 20.0 | 1.78 |
| USB | varies | varies | varies |

Further, with the exception of the SmartMedia and xD formats, memory cards include a controller chip that controls reading and writing between the memory device and the host device.

A width and/or length of a stack can be selected to conform to corresponding form factor dimensions, with constraints applied by such dimensions limiting ultimate memory capacity (by limiting media size) but not necessarily limiting the feasibility of using such a structure. However, a thickness of a memory device including a stack and magnet structures may approach or exceed a form factor thickness. Reducing memory device thickness may undesirably reduce one or more of magnetic flux density, structure rigidity, and package deformation tolerance. Embodiments of packaged memory devices and methods for fabricating such packaged memory devices in accordance with the present invention can be applied to reduce overall structure thickness to approach a thickness that conforms to one or more existing form factors to enable use of high density storage in host devices capable of interfacing with such form factors. Further, reduction in thickness can be achieved without unacceptably reducing magnetic flux density, structure rigidity, and package deformation tolerance.

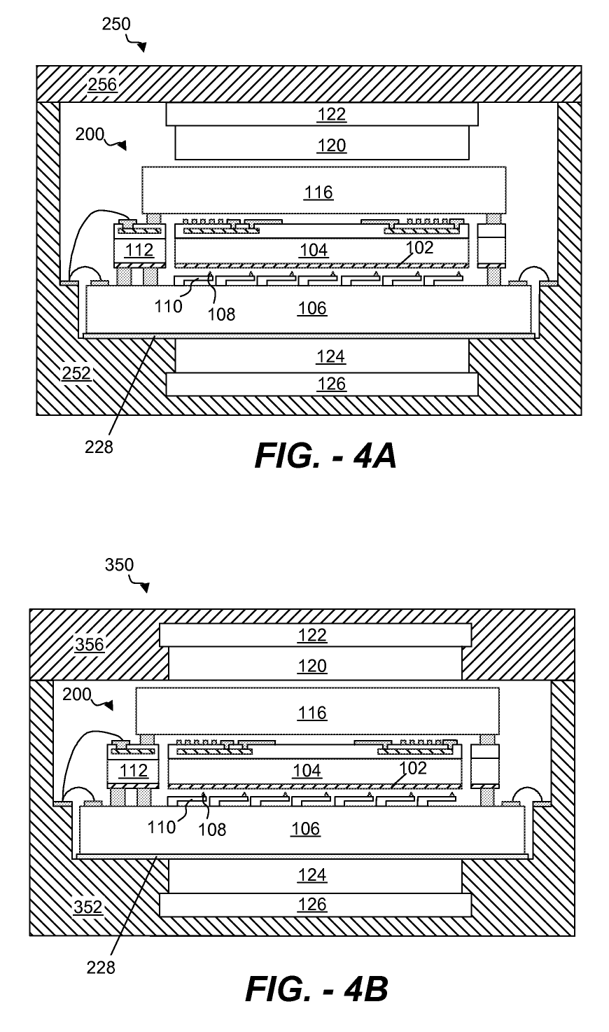

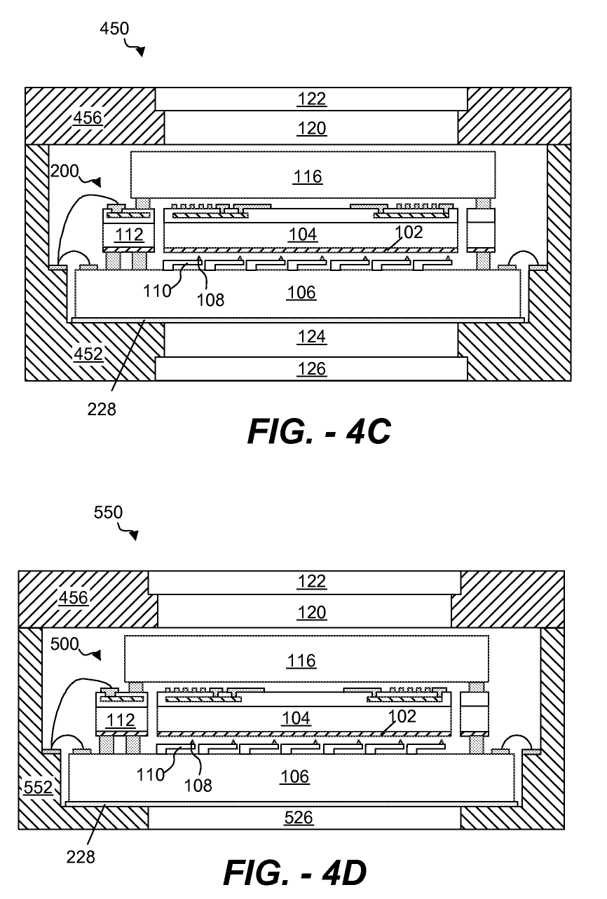

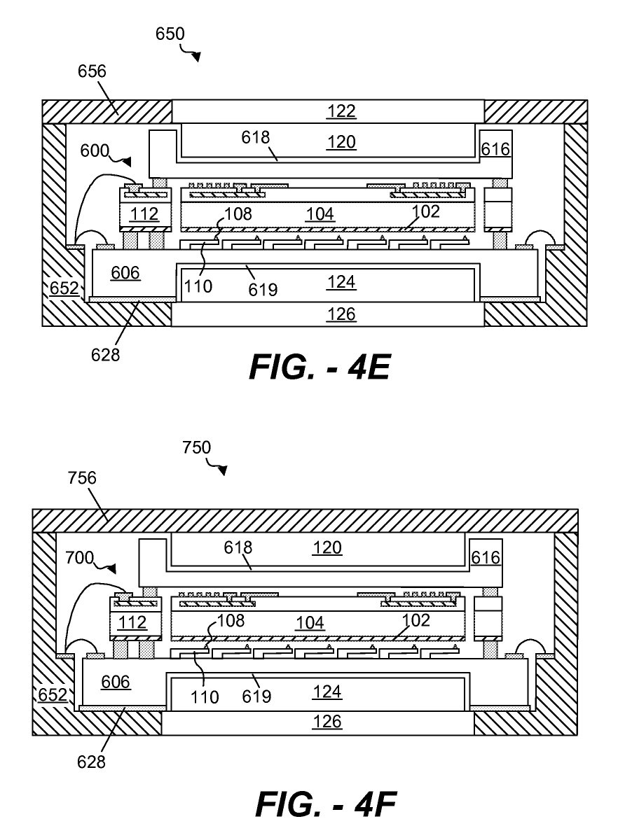

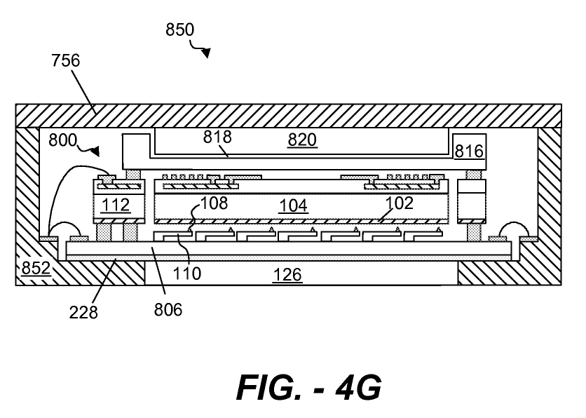

Referring to FIG. 4A, an embodiment of a memory device 200 and package 250 in accordance with the present invention is shown. The first permanent magnet 120 and flux plate 122 of the device 200 can be adhesively fixed to a lid 256, while the second permanent magnet 124 and flux plate 126 can be integrated with a package body 252 so that the second magnet structure provides structural rigidity that is within package stress tolerances in substitution of a portion of a monolithic structure. The second magnet structure can be integrated with the package body 252 using one or more of several techniques known in the art to fixedly join structures. For example, one or both of the flux plate 126 and magnet 124 can be inserted into a mold and molded by plastic (insert molded) to the package body 252. The stack of tip substrate 106, media substrate and cap 116 can then be fixedly associated with the package 250 by an adhesion layer 228 bonding the stack to package body 252 and/or the magnet 124. Alternatively, the flux plate 126 and magnet 124 can be press-fit into a cavity of the package body 252. One of ordinary skill in the art will appreciate in light of the present teaching the techniques with which the structure of FIG. 4A can be formed. Preferably, the package 250 (and packages described hereinafter) can be fabricated from low-thermal-expansion materials to reduce bending or distortion resulting from thermal expansion caused by environmental operating condition. The package body 252 can be formed from a low-thermal-expansion plastic material such as liquid crystal polymer (LCP), other plastic materials, or ceramic, for example. The lid 256 can also be formed from LCP or another polymer, a metal such as Alloy 42™ or Kovar™, or some other material known in the semiconductor packaging art. The coefficient of thermal expansion for LCP can be tailored over a wide range of temperatures to minimize thermally-induced stresses. Further, LCP provides improved hermeticity to conventional plastic packages, and at a lower cost than hermetic ceramic packages. Enclosing a memory device in a sealed package enables the pressure on the memory device to be isolated, preventing unwanted deformation of the cap 116 and tip substrate 106 due to pressure mismatch between a sealed volume inside the substrate and outside atmospheric pressure.

FIG. 4B illustrates an alternative embodiment of a memory device 200 and package 350 reduced further in thickness (and/or increased in structural rigidity) by mating the first permanent magnet 120 and first flux plate 122 with a lid 356 so that the first magnet structure provides structural rigidity that is within package stress tolerances in substitution of a portion of a monolithic structure of the lid 356. As above, the first magnet structure can be integrated with the lid 256 by one or more of several techniques, such as insert molding, and press fitting. Integrating the first magnet structure with the lid 356 allows the lid 356 to be thickened relative to the lid 256 of FIG. 4A, to improve overall rigidity of the lid 356 while optionally reducing overall package thickness.

Referring to FIG. 4C, a further embodiment of a memory device 200 and package 450 in accordance with the present invention is shown. The first and second magnet structures of the device 200 can form at least a portion of the support surface of the package 450. The magnet structures can be integrated with the package 450 using one or more of several techniques preferably providing hermetic sealing of the package. As above, one or both of the flux plate 122,126 and magnet 120,124 of the magnet structures can be insert molded to the corresponding portion of the package. Alternatively components can be press fit together, although such a technique may or may not provide a desired hermetic seal (design and fabrication tolerances may be very narrow, causing such a technique to be unreasonably costly). The stack can then be fixedly associated with the package 450 by an adhesion layer 228 bonding the stack to the magnet 124 and package body 452. It is estimated that a packaged memory device such as shown in FIG. 4A can be sufficiently reduced in thickness. In particular, thickness of tip substrate 106, the media substrate 112 and the cap 116 can be 0.7 mm, 0.2 mm and 0.5 mm, correspondingly. Thickness of magnets 120 and 124 can be 0.35 mm each and thickness of flux plates 122 and 126 can be 0.4 mm each. Thickness of adhesive layer between package 452/magnet 124 and tip substrate 106 can be 0.025 mm and gap between lid 456/magnets 120 and the cap 116 can be as small as 0.05 mm. This brings thickness of memory device shown in FIG. 4C below 3.0 mm. Further, techniques such as insert molding can reduce assembly costs and reduce adhesion layers for which process variation can be introduced.

FIG. 4D illustrates a still further embodiment of a memory device 500 and package 550 resembling the embodiment of FIG. 4C and reduced further in thickness by including a single permanent magnet 120 to generate magnetic flux across the stack. A second flux plate 526 can be insert molded to the package body 552, or alternatively components can be press fit together. The stack can then be fixedly associated with the package 550 by an adhesion layer 228 bonding the stack to the second flux plate 526 and package body 552. The reduced magnetic flux can reduce a Lorentz force that urges the platform 104 with media 102 relative to the tip substrate 106, which can reduce media access speeds. Reducing media access speeds can, for example, increase seek time, reduce a maximum read data transfer rate and/or reduce a maximum write data transfer rate. A reduction in magnetic flux can be compensated with an increase in electric field interacting with the magnetic flux. However, an increase in electric field may undesirably consume power, and potentially influence polarization of domains in a ferroelectric media.

FIG. 4E illustrates a still further embodiment of a memory device 600 and package 650 in accordance with the present invention having two magnet structures with a reduced thickness over the embodiment of FIGS. 4A-4C. The first and second flux plates 122, 126 of the first and second magnet structures of the device 600 can form at least a portion of the support surface of the package 650. The flux plates 122, 126 can be integrated with the package 650 using several techniques, such as insert molding and press-fitting (as above, preferably providing hermetic sealing of the package). To accommodate at least a portion of a first permanent magnet 120, one or more pockets 618 can be formed in the cap 616, for example by etching, milling, and/or grinding the exposed surface of the cap 616. The pockets 618 can be formed prior or subsequent to bonding of the cap 616 with the frame 112 of the media substrate. A gap between the cavity and the first permanent magnet 120, when seated in the pockets 618, can be sufficiently large to allow a desired amount of relative movement between the first permanent magnet 120 and the cap 616. The material removed from the cap 616 can generally be limited to a footprint of the first permanent magnet 120, with allowance for the gap, so that reduction of rigidity of the cap 616 can be minimized. However, preferably a gap will be sufficiently large that deformation of the lid 656 of the package 650 under normal anticipated conditions of use will not apply force to the cap 616. Likewise, to accommodate at least a portion of a second permanent magnet 124, one or more pockets 619 for receiving the magnet 124 can be formed in the tip substrate 606, for example by etching, milling, and/or grinding the back surface of the tip substrate 606. The material removed from the tip substrate 606 can be substantially limited to a footprint of the second permanent magnet 124 so that reduction of rigidity of the tip substrate 606 can be minimized. The second permanent magnet 124, fitted within a cavity of the tip substrate 606 can provide resistance to deformation of the tip substrate 606 where the gap substantially complements the second permanent magnet 124. The media stack can then be fixedly associated with the package 650 by an adhesion layer 628 bonding the stack to the package body 652.

FIG. 4F illustrates yet another embodiment of a memory device 600 and package 750 in accordance with the present invention resembling the embodiment of FIG. 4D and having two magnet structures at least partially received within pockets 618,619 formed within the cap 616 and tip substrate 606. However, in this embodiment, the lid 756 of the material is a monolithic structure to which a first permanent magnet 120 is bonded. The lid 756 supplants the first flux plate by being formed of a ferromagnetic material capable of capturing magnetic flux. The lid 756 can be formed from steel, or some other material for containing magnet flux, preferably a ferromagnetic material such as alloys containing nickel and/or iron.

FIG. 4G illustrates a further embodiment of a memory device 800 and package 850 in accordance with the present invention comprising a single permanent magnet 820 thinner than in previous embodiments and at least partially received within pockets 818 formed within a thinned cap 816. As in the previous embodiments, the lid 756 of the material is a monolithic structure to which the permanent magnet 820 is bonded. The lid 756 supplants the first flux plate by being formed of a ferromagnetic material capable of capturing magnetic flux. The lid 756 can be formed from steel, or some other material for containing magnet flux, preferably a ferromagnetic material such as alloys containing nickel and/or iron. The tip substrate 806 is thinned uniformly to reduce an overall height of the stack, and bonded by an adhesion layer 228 to the package body 852. The thinner and single permanent magnet generates a reduced magnetic flux across the coils of the electromagnetic motor. As a result, the memory device 800 can be used with lower performance characteristics (e.g., lower seek and scan speeds), or alternatively can require increased power. However, the thinner overall height of the memory device 800 may enable use in smaller form-factor memory card standards.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A packaged memory device for storing information comprising:
a stack including:
a media, and
a tip substrate having a plurality of tips extending from the tip substrate and said media being accessible to the plurality of tips;
a package lid;
a first flux plate fixedly associated with the package lid;
a package body;
a second flux plate integrated with the package body so that the second flux plate provides structural rigidity to the package body;
a permanent magnet arranged between the first flux plate and the second flux plate;
wherein the package lid forms a hermetic seal with the package body;

2. The packaged memory device of claim 1, wherein the permanent magnet is a first permanent magnet fixedly connected with the first flux plate; and
further comprising a second permanent magnet fixedly connected with the second flux plate; and
wherein the first magnet substantially maps the second magnet.

3. The packaged memory device of claim 1, wherein:
the stack further includes a cap;
the media is arranged between the cap and the tip substrate;
the media is movable relative to the tip substrate; and
the stack is connected with the second flux plate.

4. The packaged memory device of claim 2, wherein:
the stack further includes a cap;
the media is arranged between the cap and the tip substrate; and
the media is movable relative to the tip substrate; and
the stack is connected with the second permanent magnet.

5. The packaged memory device of claim 1, wherein the first flux plate is integrated with the package lid so that the first flux plate provides structural rigidity to the package lid.

6. The packaged memory device of claim 1, wherein:
the permanent magnet is fixedly connected with the second flux plate and integrated with the package body so that the permanent magnet provides structural rigidity to the package body; and
the stack is fixedly connected with one or both of the permanent magnet and the package body.

7. The packaged memory device of claim 1, wherein the second flux plate is integrated with the package body by injection molding.

8. The packaged memory device of claim 1, wherein the second flux plate is a portion of a support surface of the package body.

9. The packaged memory device of claim 5, wherein the first flux plate is integrated with the package lid by injection molding.

10. The packaged memory device of claim 5, wherein the first flux plate is a portion of a support surface of the package lid.

11. The packaged memory device of claim 1, wherein:
the stack further includes a cap;
the media is arranged between the cap and the tip substrate, and movable relative to the tip substrate;
the permanent magnet is fixedly connected with the second flux plate;
the tip substrate includes a cavity to receive at least a portion of the permanent magnet; and
when the stack is fixedly connected with the package body, the at least a portion of the permanent magnet is received within the cavity.

12. The packaged memory device of claim 2, wherein:
the stack further includes a cap;
the cap includes a first cavity to receive at least a portion of the first permanent magnet so that a gap exists between the cap and the first permanent magnet;
the media is arranged between the cap and the tip substrate, and movable relative to the tip substrate;
the tip substrate includes a second cavity to receive at least a portion of the second permanent magnet; and
when the stack is fixedly connected with the package body, the at least a portion of the second permanent magnet is received within the cavity.

13. A packaged memory device for storing information comprising:
a stack including:
a tip substrate having a plurality of tips extending from the tip substrate;
a cap;
a media arranged between the tip substrate and cap and movable relative to the tip substrate, the media being accessible to the plurality of tips;
a package lid;
a first magnet structure fixedly connected to the package lid and including a first magnet connected with a first flux plate;
a package body connectable with the package lid to form a hermetic seal;
a second magnet structure including a second magnet connected with a second flux plate;
wherein the second flux plate is integrated with the package body so that the second flux plate provides structural rigidity to the package body; and
wherein the stack is fixedly connected to one or both of the package body and the second magnet.

14. The packaged memory device of claim 13, wherein the second flux plate is integrated with the package body by injection molding.

15. The packaged memory device of claim 13, wherein the second flux plate is a portion of a support surface of the package body.

16. The packaged memory device of claim 13, wherein the second magnet is integrated with the package body so that the second magnet provides structural rigidity to the package body.

17. The packaged memory device of claim 16, wherein the second magnet is integrated with the package body by injection molding.

18. The packaged memory device of claim 13, wherein:
the tip substrate includes a cavity to receive at least a portion of the second magnet; and
when the stack is fixedly connected with the package body, the at least a portion of the second magnet is received within the cavity.

19. The packaged memory device of claim 13, wherein the cap includes a first cavity to receive at least a portion of the first magnet so that a gap exists between the cap and the first magnet.

20. A packaged memory device for storing information comprising:
a stack including:
a tip substrate having a plurality of tips extending from the tip substrate;
a cap;
a media arranged between the tip substrate and cap and movable relative to the tip substrate, the media being accessible to the plurality of tips;
a first flux plate;
a package body connectable with the first flux plate to form a hermetic seal;
a magnet structure including a magnet connected with a second flux plate;
wherein the second flux plate is integrated with the package body so that the second flux plate provides structural rigidity to the package body; and
wherein the stack is fixedly connected to one or both of the package body and the second magnet.

21. The packaged memory device of claim 20, wherein the second flux plate is integrated with the package body by injection molding.

22. The packaged memory device of claim 20, wherein the second flux plate is a portion of a support surface of the package body.

23. The packaged memory device of claim 20, wherein the magnet is integrated with the package body so that the magnet provides structural rigidity to the package body.

24. The packaged memory device of claim 20, wherein the magnet is integrated with the package body by injection molding.

25. The packaged memory device of claim 20, wherein:
the tip substrate includes a cavity to receive at least a portion of the magnet; and
when the stack is fixedly connected with the package body, the at least a portion of the magnet is received within the cavity.

26. The packaged memory device of claim 20, wherein the magnet is a second magnet, and further comprising a first magnet fixedly connected with the first flux plate and substantially mapping the second magnet.

27. The packaged memory device of claim 26, wherein the cap includes a first cavity to receive at least a portion of the first magnet so that a gap exists between the cap and the first magnet.

28. The packaged memory device of claim 27, wherein:
the tip substrate includes a second cavity to receive at least a portion of the second magnet; and
when the stack is fixedly connected with the package body, the at least a portion of the second magnet is received within the second cavity.

29. A packaged memory device for storing information comprising:
a stack including:
a tip substrate having a plurality of tips extending from the tip substrate;
a cap;
a media arranged between the tip substrate and cap and movable relative to the tip substrate, the media being accessible to the plurality of tips;
a first flux plate;
a second flux plate;
a package body connected between the first flux plate and the second flux plate to form a hermetic seal;
a magnet arranged between the first and second flux plates;
wherein the stack is fixedly connected to one of the first flux plate, the second flux plate and the magnet.

30. The packaged memory device of claim 29, wherein:
the magnet is fixedly connected to one of the first flux plate and the second flux plate;
and
one of the tip substrate and the cap includes a cavity to receive at least a portion of the magnet.
